(19) United States
(12) Patent Application Publication
(10) Pub. No.: US 2010/0197288 A1
(43) Pub. Date: Aug. 5, 2010

(54) Call Routing Method and Device

(75) Inventors: Michael Camilleri, Berkshire (GB); Jose Luis Merino Gonzalez, Malaga (ES)

Correspondence Address: Saul Ewing LLP (Philadelphia), Attn: Patent Docket Clerk, 2 North Second St., Harrisburg, PA, 17101, US

(73) Assignee: Ghost Telecom Limited, Berkshire (GB)

(21) Appl. No.: 12/295,888

(22) PCT Filed: Apr. 10, 2007
(86) PCT No.: PCT/GB07/01322

§ 371 Date: Mar. 23, 2010

(30) Foreign Application Priority Data
Apr. 10, 2006 (GB) 0607102.1

(51) Int. Cl. H04W 40/00; H04M 3/42; H04W 4/16

(52) U.S. Cl. 455/416; 455/445; 455/417

(57) ABSTRACT

A wireless device uses a software application that enables the device to communicate with a remote service provider device over a wireless link. The user initiates a call to a third party by dialling the telephone number of the third party the user wishes to communicate with. The software application then automatically initiates a data communication to the remote service provider and automatically providing to the remote service provider device all the required information needed by the service provider device to correctly route the communication.

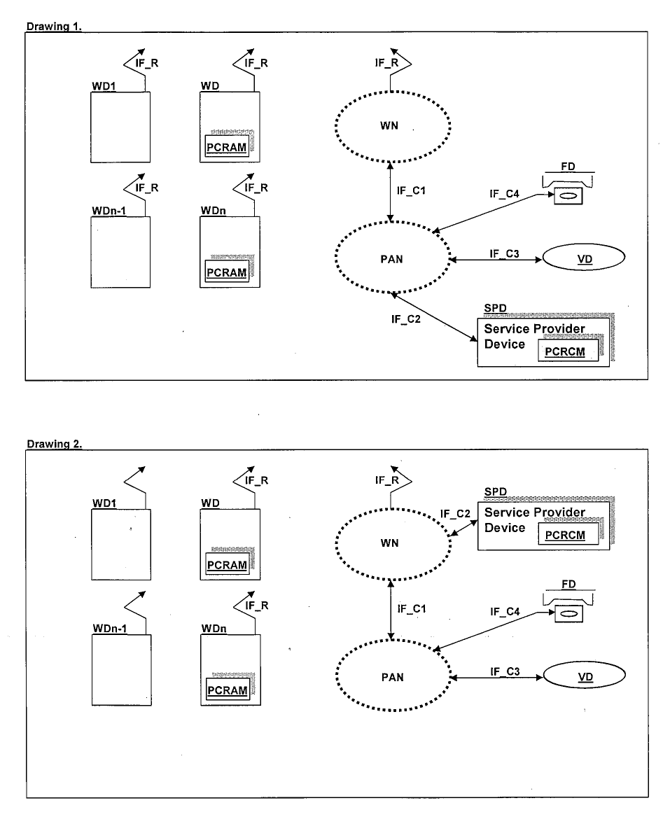

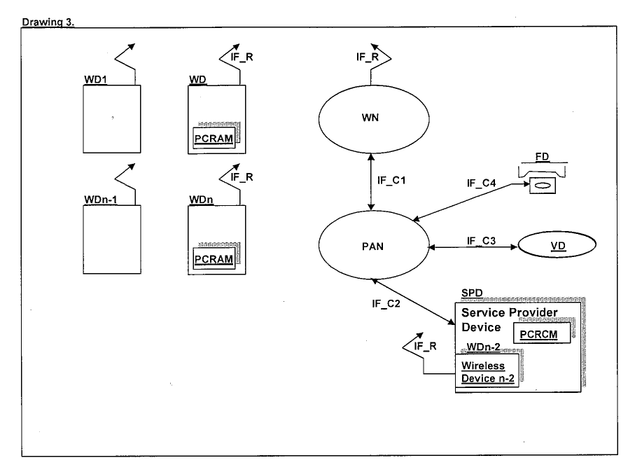

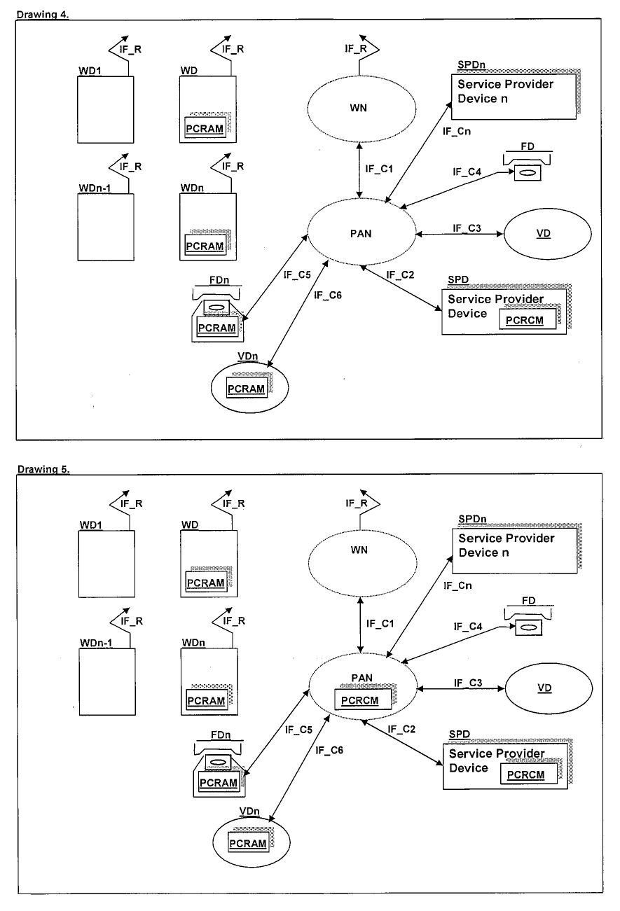

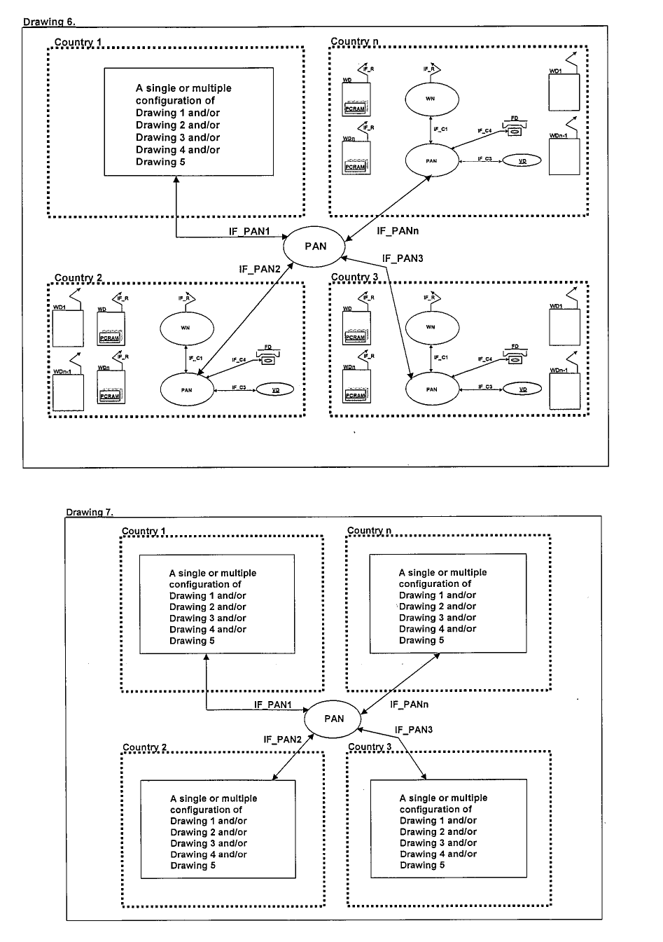

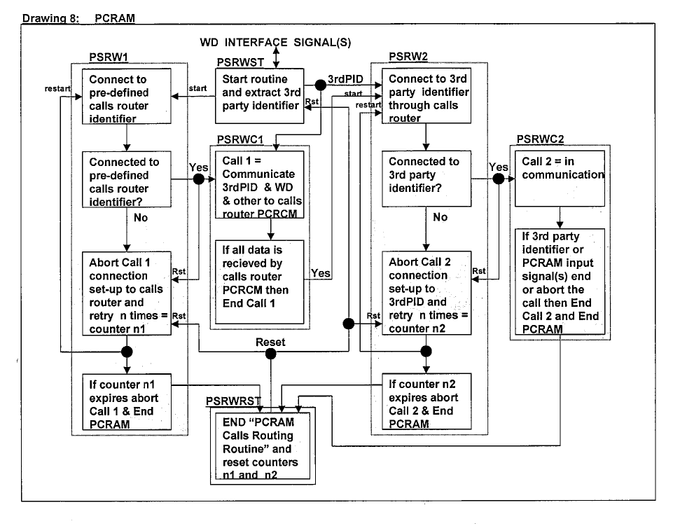

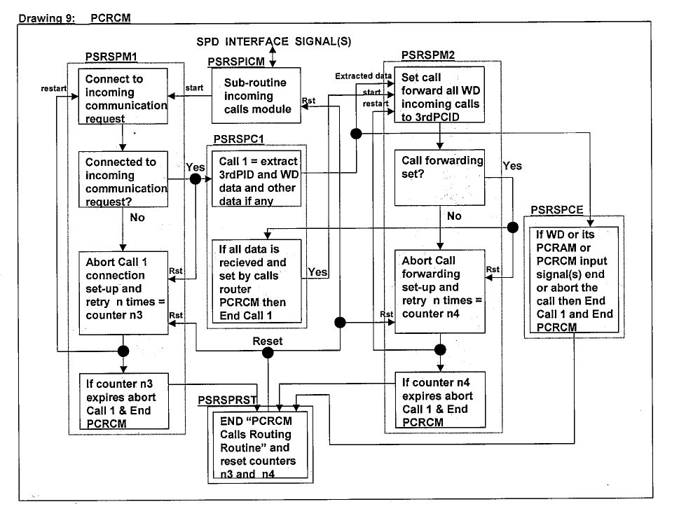

### FIELD OF THE INVENTION

This invention relates in general terms to how calls can be routed from private mobile handsets (e.g. cell phones/mobile telephones). In particular, this invention describes a method and architecture(s) for wireless devices call(s) routing, specifically for routing outgoing voice and data communications between
any wireless device and/or fixed device and/or voice over internet protocol devices AND
any other wireless device and/or fixed device and/or voice over internet protocol devices.

It is also potentially applicable to incoming communications and can also be scaled to large private and/or public networks.

### BACKGROUND OF THE INVENTION

Public and private switching networks (both wireless networks—WN and fixed networks—FN) and private automatic branch exchange (PABX or PBX) can now handle voice and/or data, allowing simplex and/or duplex calls routing for voice calls, video calls and data calls such as VoIP calls. Some smaller call router devices for private and small businesses can now handle call routing between public switched telephone network (PSTN) and voice over internet protocol (VoIP) and vice-versa. However, these devices often require a personal desktop or portable computer (PC) permanently connected to the internet. In some cases, there is a further requirement for additional hardware call router devices (HWCRD) connected between the PC and PSTN, typically interconnecting the additional HWCRD and PC with their corresponding universal serial bus (USB) interface, mainly in order to run a third party or in-house proprietary VoIP application and to allow interfacing and power.

In other mass market technologies, the call routing is strictly interfaced by a PC permanently connected to the internet; such a PC runs a third party or in-house proprietary VoIP application, allowing incoming voice calls from and to an external hardware device connected through their USB with the PC. The PC has to be permanently logged onto a user account and permanently switched-on however.

These types of call routers, jointly referred to as CR, require the originating call party, for example a wireless device user, that wishes to be routed through to a VoIP user or a fixed home phone user, to originate the call manually from a wireless device or mobile phone, fixed phone or VoIP phone. Manual call origination involves the following steps:
calling the CR phone number associated with its connected PSTN or the VoIP address associated with its VoIP phone and then
when in voice call mode, following pre-recorded voice instructions from the CR to enter manually a security code and then the VoIP user address or PSTN phone number or wireless device phone number that it wishes to talk to.

The same applies vice-versa, meaning for example when a VoIP user calls the phone number associated with the PSTN connected to the CR, then, when in voice call mode, the VoIP user has to (a) select manually the outgoing calls function, (b) check that he has sufficient credit and then (c) following the CR instructions, the user has to enter the phone number to which it wishes to be routed by the CR.

This is very complex and limits the use of such systems to the more sophisticated or technology savvy users. But even then it fails to provide sufficient security provisions for abuse of these call router systems by unauthorised third parties. A further major drawback is that the CR with an external HWCRD is typically connected to the user's home PSTN, thus monopolising this communication link most of the time. This prevents simultaneous use: say one user uses the PSTN and another user, perhaps in the same family, use his WD; it is often the WD that calls its home PSTN to be call routed through the external hardware connected to its home computer. But the home computer has to be permanently connected to the mains power supply and permanently logged on to a user account to allow a call routing application to run.

What is needed is a method that gives users the ability to route calls more efficiently. The method should be available to those with only one or even no PSTN connection, so long as they have wireless coverage from a Public wireless system or Wireless Network. The method should allow each authorised wireless device user the freedom to choose the most appropriate call set-up route, no matter where they are in the world. In particular, the method should enable the user to select the cheapest option for each call set-up route for any outgoing traffic, such as outgoing voice- and data-calls, but without the need for a home computer or PC. The method should provide access control so that it can be used only by authorised users.

The following acronyms are used in this specification:

| Acronym | Meaning |
|---|---|
| 3rdPID | third party identifier |
| CR | call router |
| FD | fixed device (e.g. wireline telephone) |
| FN | fixed network |
| HWCRD | hardware call router devices |
| IF-R | wireless interface |
| PAN | public access network |
| PCID | pre-defined caller identification |
| PCRAM | proprietary call routing application module |
| PCRCM | proprietary call routing control module |
| PCRCM-CID | proprietary call routing control module |
| | caller identifier |
| PSTN | public switched telephone network |
| SIMN | subscriber identity module number |
| SPD | wervice provider device |
| SPD-CID | service provider device caller identifier |
| VD | VoIP telephone |
| VoIP | voice over internet protocol |
| WD | wireless device |
| WN | wireless network |

### SUMMARY OF THE INVENTION

The invention is a method of enabling call routing from a wireless device, comprising the steps of:
(a) the wireless device using a software application that enables the device to communicate with a remote service provider device over a wireless link;
(b) the user initiating a call to a third party by dialling the telephone number of the third party the user wishes to communicate with;
in which the method comprises the further steps of:
(c) the software application then automatically initiating a data communication to the remote service provider and automatically providing to the remote service provider device all the required information needed by the service provider device to correctly route the communication.

Optional implementation details include the following: The required information automatically provided by the software application over the data communication to the remote service provider device includes one or more of:
the telephone number of the third party
a device identifier.
a SIM number for the device
a user account login and user account password.

The remote service provider device verifies permission to use the remote service provider device. Then, the remote service provider device automatically arranges for voice communication between the user and the third party. The remote service provider device may then terminate the data communication.

The new voice communication can be a call to the user and another call to the third party, which is then conferenced or joined together. Alternatively, the wireless device automatically makes a voice call to the remote service provider device and that voice call is automatically forwarded or diverted to the third party. Another option is for the new outgoing communication to be an automatic voice call back to the user and another call to the third party, which are then conferenced or joined together.

The data communication can be over GPRS and can be set up by the device dialing an IP address.

The software application can be downloadable by the user to the wireless device; the download can be by SMS or WAP.

The remote service provider device can also be accessed using a computer over the internet. The remote service provider device decides on the appropriate routing for a given call request from the wireless device. It may automatically determine the lowest cost route from a number of routes provided by different operators. The route can be over IP, or wired or wireless, or a combination of any of these.

Another aspect of the invention are a wireless device when running a software application that enables the method defined above to be performed.

A final aspect is a voice call when routed using the method defined above.

In the preferred implementation, call routing functionality is distributed across both a remote service provider device and also the wireless device. The call routing element on the wireless device is the ‘proprietary call routing application module’ PCRAM. The call routing element on the remote service provider device is the PCRCM. The remote service provider device is described as the SPD.

In this implementation, there is a method for interfacing, interconnecting or communicating a wireless device (WD) with an embedded, integrated or built-in (PCRAM), with any wireless device and/or fixed device and/or voice over internet protocol device by routing communication(s) through a service provider device (SPD). The wireless device includes an embedded, integrated or built-in proprietary call routing application module” (PCRAM). The service provider device has an embedded, integrated or built-in “proprietary call routing control module” (PCRCM). The communications can be to and/or from a wireless device and/or a fixed device and/or voice over internet protocol device controlled by and/or through the service provider device.

In use, all that is required is for the wireless device or mobile phone user to download the proprietary call routing application module PCRAM into its wireless device or mobile phone and start using his phone in the normal manner, by simple dialling the phone number of the person it wishes to speak to. The built-in proprietary call routing application module PCRAM will automatically enable or facilitate the performance of all the required functions needed to initiate cost-effective call routing without the user even be aware of it. In a second, the communication set-up will be established automatically, as described below.

As wireless coverage by cellular networks is available almost world-wide and mobile phones penetration is so high, and in some geographies even outstripping the penetration percentage of fixed phone users, the present invention addresses a real need and demand for mobile handset phones users to be able to make all their outgoing calls from their mobile phones, with mobile coverage and a valid subscriber identity module subscription (SIM). Outgoing calls can be made at any time in any place, calling to any place in the world, at the worst case at the cost of two- or in most cases only one-local call rate or even free of charge in some cases, without having the need to leave their home computer permanently switched on or permanently running any applications. The wireless device or mobile phone can be used in the same way the user, used it before.

### BRIEF DESCRIPTION OF THE DRAWINGS

DRAWING. 1 shows one implementation of the present invention. A proprietary call routing application module(s) (PCRAM) and proprietary call routing control module(s) (PCRCM) are shown. The proprietary call routing application module(s) (PCRAM) is built-into each of several wireless devices (WD). Each WD communicates through a wireless interface (IF_R) and a wireless network (WN) and with or through a public access network (PAN). Communication is with a service provider device (SPD) and its built-in proprietary call routing control module(s) (PCRCM) and any such other wireless-, fixed device (FD)- and/or voice over internet protocol (VD) devices.

DRAWINGS. 2 to 6 are implementations of the present invention with different wireless network (WN) and public access networks (PAN) architectures. The figures show wireless devices (WD to WDn) associated with the WN, including wireless devices and any other devices (both with and without a built-in proprietary call routing application module (PCRAM)). Also shown are service provider devices SPD and other devices (PC, FDn, VDn) with and/or without a built-in proprietary call routing control module (PCRCM). The SPD, with a built-in PCRCM, can be located in the same country as the PAN to which the SPD interconnects with, or in a different country. The WD, with a built-in PCRAM, may be located in the same country as the WN, to which it is associated with, or in a different country.

DRAWING. 7 shows some of the different combinations of the present invention in flowchart form. The PCRAM may include all of the shown sub-modules and/or sub-routines, or any single or multiple combination or addition thereof or an equivalent of each such sub-module(s) or addition performing a similar function.

DRAWING. 8 shows some of the different combinations of the present invention with respect to a proprietary call routing control module (PCRCM) flowchart. The PCRCM may include all of the shown sub-modules and/or sub-routines or any single or multiple combination or addition thereof or an equivalent of each such sub-module(s) or addition performing a similar function.

### DETAILED DESCRIPTION OF THE DRAWINGS

Overview

In an implementation of this invention, a wireless device (WD) has a built-in proprietary call routing application module (PCRAM), with user assigned parameters. The PCRAM initiates call routing functionality that has in the past been restricted to a remote server: call routing functionality is in essence distributed across a remote server and the client device. The call routing element on the client (i.e. the mobile telephone or wireless device) is the PCRAM. The call routing element on the server side is the PCRCM. The server side is described as the SPD.

When the user dials a third party identifier (3rdPID), then the PCRAM will through the WD and its wireless interface IF_R set up a communication by connecting to a proprietary call routing control module caller identifier PCRCM-CID, and will then communicate with the proprietary call routing control module (PCRCM), built-into a service provider device (SPD). PCRCM-CID is typically an IP address, wireless phone number or a fixed phone number. The PCRAM will provide to the PCRCM the user account login and password, if available and if activated by the user, its own WD identifier or subscriber identity module number (SIMN) as security check for authorisation and the 3rdPID that the WD user wishes to communicate with. The communication from PCRAM to PCRCM will typically go via a proprietary call routing control module caller identifier PCRCM-CID and then a service provider device caller identifier SPD-CID (in some implementations, the PCRCM-CID and the SPD-CID are the same ID).

The PCRCM confirms the authorisation, provided the 3rdPID is an authorised user of such service by comparing it to its authorised users database, and then the PCRCM allows access to its parameters settings and will set its corresponding user parameters, in particular the call forwarding to ON for all future calls that it will receive to its associated service provider device caller identifier SPD-CID. The PCRCM will then terminate the communication with the WD's PCRAM.

This previously explained data exchange between the PCRAM and the associated PCRCM typically takes only a few seconds. Then, the PCRAM will initiate automatically a new outgoing communication to the associated SPD-CID. The SPD will then automatically call forward or route the incoming communication received at the SPD-CID originated by the PCRAM, directly to the third party identifier (3rdPID) as set within its associated PCRCM parameters. It will initiate a further communication to the WD and conference or join the two communications in together. This last process is perceived as being very fast as the WD user will instantly hear an audio dial feed back or ringing feed back (dialling- or ringing-tone) as a consequence of call set-up or communication set-up to the third party identifier (3rdPID). This is followed by the actual communication when the third party user accepts the incoming call. Such communication between the WD, with a built-in PCRAM, user and the 3rdPID user will continue until one of them or both terminate or end the communication.

Specifically, DRAWING. 1 is a block diagram of a wireless communications system, showing the preferred integration embodiment of the present invention. For this exemplary embodiment, there are shown wireless devices (WD1 and WDn-2), plus other wireless device (WD and WDn), each with a built-in proprietary call routing application module (PCRAM). In addition, DRAWING 1 shows a fixed device (FD), a voice over internet protocol device (VD), a service provider device (SPD), with a built-in proprietary call routing control module (PCRCM), a wireless network (WN) and a Public Access Network (PAN), interconnected between each other. The network provides connection for voice and data communication between the WD and the wireless network through the wireless interface IF_R, which in turn allows connection to any communication device connected (by wire or wirelessly) to such wireless networks or public access network, through the wired and/or wireless interfaces IF_C (IF_C1 to IF_C4) to any such other wireless device, fixed device and/or voice over internet protocol device.

DRAWING 1 is to be understood such that any single device, network or interface can be extended to multiple instances—e.g. WD to WDn, FD to FDn, VD to DVn, WN to WNn, SPD to SPDn, PAN to PANn, IF_R to IF_Rn and IF_C to IF_Cn.

Referring to DRAWING. 1, there are also shown two wireless devices (WD1 and WDn-1), without a built-in PCRAM, and two wireless devices (WD and WDn) of the present invention, which do have an embedded, integrated or built-in a PCRAM. The wireless devices are configured in accordance with a combination of technologies used in the field of handheld wireless devices and personal digital handheld wireless devices, such as but not limited to (for example) wireless phones, cellular phones, mobile phones, hand held radio frequency digital communication devices, personal digital assistants and so called smart-phones.

Referring to DRAWING. 1, there is also shown a service provider device SPD, which has an embedded, integrated or built-in PCRCM. The SPD is configured in accordance with a combination of technologies used in the field of service provider devices and computing and/or switching devices, such as (but not limited to) public access network servers, internet servers, voice over internet protocol gateway servers, personal desktop and/or portable computers, home location registers, PBX or PABX, which can communicate with the public access networks and/or the wireless networks as described herein after.

The PCRAM is capable of detecting the outgoing calls or communications made on a WD requests in the normal way, or alternatively made by means of a pre-programmed or pre-defined hotkey on the WD. When the user dials a third party identifier, for example the WD user calls a fixed phone number located in a different country, then the PCRAM will, through the WD it is built-into, and its wireless interface IF_R, set up a data communication. This can be for example via GPRS to the PCRCM-CID, which typically uses an internet protocol address. PCRCM-CID communicates with the associated PCRCM, and provide the PCRCM with the WD identifier or subscriber identity module number (SIMN) as a security check for authorisation and the third party number (3rdPID) that the WD user wishes to speak to.

The PCRCM then confirms the authorisation to allow access to its parameters settings, provided by the PCRAM. The PCRCM will set these parameters, and in particular the call forwarding parameter to ON for all future calls that it will receive to its associated SPD incoming call routing identifier (SPD-CID), typically being a wireless phone number or a fixed phone number. Then, the PCRCM will terminate the communication with the WD's PCRAM. This GPRS data exchange between the PCRAM and the associated PCRCM typically takes only a few seconds and costs very little because the quantity of data is minimal. The PCRAM will then initiate automatically a new outgoing voice call to the associated SPD-CID and then the SPD will automatically call forward or route the incoming call, originated by the PCRAM, to the third party identifier (3rdPID) as set within its associated PCRCM parameters and the WD; it will then join the two calls. This last process is perceived as being very fast as the WD user will instantly hear an audio dial feed back or ringing feed back from the third party caller dialling or ringing tone. When the third party accepts his incoming voice call they (the WD mobile originated call user and the third party) can communicate with each other until one of both parties ends or terminates the call or communication.

The SPD is typically a voice over internet protocol based proprietary or a third party proprietary call router application server; it has gateways from and to fixed networks and wireless network users across most countries. The SPD is accessible also by any computer connected to the internet, typically through a user account without user login and/or user password, by calling into a pre-defined call-in phone assigned to such user account. It is typically with such SPD user account that the PCRCM interfaces with; the WD's PCRAM only has to automatically exchange, by connecting to and communicating with the user account internet protocol address (i.e. PCRCM-CID), the required parameters such as user account login and/or password and in particular the third party identifier with whom it wishes the SPD user account associated call-in phone (SPD-CID) to be call forwarded to.

The call forwarding function has been set in the corresponding user account by the PCRCM when it made its first data connection by calling the user account internet protocol identifier (PCRCM-CID). When the WD's PCRAM makes its automatic new voice connection to the corresponding user account call-in phone number (SPD-CID), the corresponding SPD user account call-in will be automatically forwarded or routed through to the third party the WD user wishes to speak to.

In this way, the corresponding SPD user account parameters do not have to be set through a computer connected through the internet manually. This computer can be switched off because the PCRCM resides on the internet or inside the SPD, whilst these previous functions are now performed by the PCRAM built-into the WD. The PCRAM and

PCRCM automatically do all that is required in a matter of seconds and connect the WD user to the third party identifier it wishes to speak to or to communicate voice and/or data with. A voice call and/or a video call originated by the WD is readily achieved, as is a call originated by a third party it wishes to communicate with, when the WD's PCRAM sets the call back function to ‘on’ state within the corresponding user account of the SPD associated with and controlled by the corresponding PCRCM.

DRAWINGS 2 to 5, show some of the preferred integration embodiments of the Proprietary Calls Routing Applications Module (PCRAM) and the Proprietary Calls Routing Control Module (PCRCM), particularly within a Wireless Device (WD) and a Service Provider Device (SPD), which in the context of the foregoing are self explanatory. These drawings basically show the integration of a single or multiple PCRAM and a single or multiple PCRCM within a wireless device and a service provider device respectively, within the over-all architectures interconnected and/or communicating with one or more wireless networks WN, public access networks, other wireless devices, fixed devices, voice over internet protocol devices and other service provider devices. The Drawings also show the integration of a PCRAM within a wireless device, fixed device and a voice over internet protocol device and, a PCRCM within a service provider device and a public access network, particularly in Drawing 4 and 5.

DRAWINGS 6 and 7, show some of the preferred implementations of the invention at a macro level, by combining the architectures and interconnections of the embodiments of the present invention as shown previously in Drawings 1 to 5.

DRAWINGS 7 and 8, show some of the preferred implementations of the PCRAM and PCRCM respectively of this invention at the flow chart level.

Implementations of the invention provide an advantage allowing any wireless device (WD) with a built-in proprietary call routing application module (PCRAM) and/or a service provider device (SPD) with a built-in proprietary call routing control module (PCRCM) to communicate with each other and establish the calls routing for the voice and/or data calls originated by the WD.

Moreover this invention provides an advantage allowing any wireless device, with a built-in PCRAM, associated with the PCRCM built-into a SPD, to choose the call routing for the WD originated outgoing calls. This is done by communicating the identity of the third party with whom the WD wishes to communicate with to the PCRCM though its associated caller identifier (PCRCM-CID). The WD connects and communicates with the SPD caller identifier associated with the corresponding SPD-CID. The WD will then be able to communicate directly with the third party.

This ability to interconnect the WD and the SPD, respectively controlled by a PCRAM and the associated PCRCM, is particularly advantageous for WD international outgoing data and/or voice call routing. Currently, freedom of choice is highly restricted because call routing is performed typically by the wireless network (WN) which a user is subscribed to or associated with. But the choice is now, with this invention, fully in the hand of the end user of any virtual wireless network or wireless network for any WD, with a built-in PCRAM, which cam communicate with a SPD, with a built-in PCRCM, as described above. The WD can for example provide parameters to the PCRCM that define a choice of network or tariff. Alternatively, the SPD can itself automatically determine the cheapest route from a number of routes provided by different operators, for example over IP, wired or wireless networks, or any combination of these.

There are many variations and improvements within the scope of this invention. The PCRAM could reside in the wireless networks' end-users wireless device(s) (WDn) and/or fixed public access networks' end-users fixed devices (FDn) and/or voice over internet protocol end-user devices (VDn). The PCRCM could reside in the service provider device(s) (SPDn) and/or wireless network (WN) and/or fixed public access network (PAN) and/or an internet server and/or personal computer (PC).

This could in effect allow the setting-up of a market competitive mobile service provider, thus introducing more competition in the wireless and/or cellular market place, benefiting end-users, without the need for any wireless device and/or wireless handheld and/or mobile handset and/or cellular handset user to change its current subscriber identity module (SIM) number subscription, or its current home wireless network operator in the country the end-user resides.

But end-users benefit from the advantages of this invention by simply downloading and/or integrating and/or embedding a PCRAM into his WD and simply by subscribing to the service provider as described herein, which has a SPD with a built-in PCRCM. This will allow all such WD end-users, where the WD has a built-in PCRAM, to make use of all the benefits as described, thus allowing the previous mentioned WD end-user to keep its original phone number “subscriber identity module” (SIM) number (SIMN) associated with the corresponding local home wireless network (WN) or associated to a virtual network (VN) based in the country (Country 1) where the end-user resides or a mobile service provider with a built-in PCRCM, based in the country (Country 1) where the end-user resides or in any such other country (country 2 to n). The end-users benefit from the advantageous tariffs whenever applicable for his originated outgoing calls associated with the SIMN and the corresponding roaming destinations, where there is available another SPD, with a built-in PCRCM. This allows in particular all outgoing calls originated by such WD, with a built-in PCRAM, originated from any country with a SPD, with a built-in PCRCM, to any third party in the world at a cost of equal to less then two local calls, or in some cases at the call rate of one local call rate, or even in some cases free of charge.

The architecture as described herein, in as far as related to wireless devices and service provider devices, respectively with a built-in proprietary call routing application module (PCRAM) and a proprietary call routing control module (PPCRCM), allows scalability. The communications architecture and its combinations, interconnecting to wireless network(s) and/or public access network(s) and/or service provider devices (with or without a built-in PCRCM), and/or wireless devices (with or without a built-in PCRAM), and/or fixed devices and/or voice over internet protocol devices, can be the same or different for any country that the associated service provider, with a built-in PCRCM, has agreements with: the outgoing traffic tariffs for wireless devices, with a built-in PCRAM, can be more advantageous than the tariffs for a wireless device without a built-in PCRAM.

Summary of Implementation Details

The following are optionally performed by or present in preferred implementations.

In a preferred implementation, a communication system consists of a proprietary call routing application module (PCRAM) and a proprietary call routing control module (PCRCM) capable of communicating between or with each other through a wireless interface (IF_R) and a wireless and/or wired interface (IF_C) respectively.

A wireless device (WD) has a built-in proprietary call routing application module (PCRAM), capable of communicating with a service provider device (SPD) and a built-in PCRCM. The PCRCM is capable of routing WD communication(s) to and/or from another wireless device (WD), with or without a built-in PCRAM, and/or a fixed device

(FD) and/or a voice over internet protocol device (VD). This routing can be through Wireless Networks' (WN) wireless interfaces (IF_R) and/or Public Access Networks' (PAN) public interface (IF_C and/or IF_PAN) respectively.

Similarly, a service provider device (SPD) with a built-in proprietary call routing control module (PCRCM), is capable of communicating with wireless devices (WD), each with a built-in PCRAM and is capable of routing WD communication(s) to and/or from another wireless device (WD), with or without a built-in PCRAM, and/or fixed devices (FD) and/or voice over internet protocol devices (VD). This routing can be through Public Access Networks' (PAN) public interface (IF_C and/or IF_PAN) and/or Wireless Networks' (WN) wireless interfaces (IF_R) respectively.
WD, WD1, to WDn-2, WDn-1,WDn are wireless devices and/or wireless battery powered handheld devices in any available current and future analogue and/or digital technologies respectively.
SPD to SPDn are service provider devices and/or computing devices and/or server devices in any available current and future analogue and/or digital technologies respectively.
FD to FDn are fixed devices and/or fixed telephone devices in any available current and future fixed and/or wireless analogue and/or digital technologies respectively.
VD to VNn are voice over internet protocol devices in any available current and future fixed and/or wireless analogue and/or digital technologies respectively.
WN to WNn are wireless networks in any available current and future analogue and/or digital technologies respectively.
IF_R to IF_Rn are wireless interfaces in any available current and future analogue and/or digital technologies respectively.
PAN to PANn are public access networks and/or switching networks in any available current and future analogue and/or digital technologies respectively.
IF_C1 to IF_Cn and IF_PAN1 to IF_PANn are wired and/or wireless interfaces in any available current and future analogue and/or digital technologies respectively.

Any individual or multiple SPD, with a built-in PCRCM, may be located in the same geographical location (country 1) or in a different geographical location (country 2 to country n) than the WD, with a built-in PCRAM, with whom it will interconnect and/or communicate with.

Any individual or multiple PCRCM may be built-into or performed by a single or multiple SPD and/or PAN and/or WN.

Any individual or multiple SPD, without a built-in PCRCM, is capable of downloading and installing a single or multiple PCRCM.

Any individual or multiple SPD, with a built-in PCRCM, also has additionally built-in a single or multiple wireless device (WD or WDn-1), thus allowing additionally in- and/or out-bound PCRCM communications though the corresponding SPD and the additional single or multiple interface IF_R.

Any individual or multiple WD is capable of downloading and installing a single or multiple PCRAM.

Any individual or multiple WD has at least one or more built-in proprietary call routing application modules (PCRAM).

Any individual or multiple SPD has at least one or more built-in proprietary call routing control module (PCRCM).

Any individual (or multiple) proprietary call routing application module (PCRAM) is capable of interfacing with the corresponding WD internal interface signals such as to allow the WD user to set certain parameters, such as (but not limited to):
one or more pre-defined caller identifications (PCID), such as (but not limited to) phone numbers and/or internet protocol addresses.

The PCRAM can also detect the 3^{rd} (third) party caller identification (3rdPID) with whom the WD user wishes to communicate with.

Each time the user of the WD, with a built-in PCRAM, enters a 3rdPID to communicate with, then the PCRAM will at first communicate with the PCRCM through a first communication set-up with a pre-defined caller identification, proprietary call routing control module caller identifier (PCRCM-CID).

The PCRAM will transfer all required data for the corresponding PCRCM parameters settings, such as (but not limited to) transferring the WD own subscriber identity module (SIM) number (SIMN), the 3rdPID and any other data needed to enable the PCRCM to optimally route the call. Once the PCRAM has sent all the relevant data to the corresponding PCRCM, then the PCRAM will terminate the previous mentioned first communication with the corresponding PCRCM. The PCRAM then initiates through the WD and its interface IF_R a new communication to a pre-defined caller identification service provider device caller identifier (SPD-CID). SPD-CID is different to the previously mentioned PCID. Alternatively, the PCRAM will continue with its first communication if the first mentioned PCID (PCRCM-CID) and the second mentioned PCID (SPD-CID) are set by the WD user as being the same caller identifiers. In this way, the WD user will be in communication with the 3rdPID, through the calls routing performed by the corresponding SPD, with its corresponding built-in PCRCM, until the WD user or the 3rdPID user ends or terminates the voice and/or data communication.

Any individual proprietary call routing application module (PCRAM) may include some or all of the following sub-modules and/or sub-routines or any single or multiple combination thereof or an equivalent of each such sub-module(s) performing a similar function:
Proprietary sub-routine wireless start (PSRWST)
Proprietary sub-routine wireless one (PSRW1)
Proprietary sub-routine wireless two (PSRW2)
Proprietary sub-routine wireless call one (PSRWC1)
Proprietary sub-routine wireless call two (PSRWC2)
Proprietary sub-routine wireless reset (PSRWRST)

Any individual or multiple proprietary call routing control module (PCRCM) is capable of interfacing with its corresponding SPD internal interface signals such as to allow the SPD to set certain parameters, such as but not limited to one or more call diverts to phone numbers and/or internet protocol addresses, and detect the 3^{rd} party caller identification (3rdPID) with whom the corresponding WD user wishes to communicate with.

Each time the SPD, with a built-in PCRCM, receives a 3rdPID when communicating with the corresponding PCRAM, meaning with the corresponding SIMN, the PCRCM will at first communicate with the corresponding PCRAM through a first incoming communication originated by the corresponding PCRAM, through the WD it is built-into and which set up this first communication to the PCRCM-CID. The PCRCM will store and/or set all required data for the corresponding PCRCM settings, such as but not limited to storing and setting the WD own subscriber identity module number (SIMN), the 3rdPID and any other necessary data.

Once the PCRCM has received and/or set all the relevant data received from the corresponding PCRAM, then the PCRCM will terminate the previous mentioned first communication with the corresponding PCRAM, and the SPD. The PCRCM will from then on perform the functions set as mentioned previously, for example (but not limited to) call divert any incoming communication, originated from the corresponding wireless device (WD) identifier SIMN and received at its corresponding SPD-CID, directly to the 3rdPID.

Any individual or multiple proprietary call routing control module (PCRCM) may include one or more of the following sub-modules and/or sub-routines or any single or multiple combination thereof or an equivalent of each such sub-module(s) performing a similar function:
Proprietary sub-routine service provider incoming calls module (PSRSPICM)
Proprietary sub-routine service provider module one (PSRSPM1)
Proprietary sub-routine service provider module two (PSRSMP2)
Proprietary sub-routine service provider call one (PSRSPC1)
Proprietary sub-routine service provider call end (PSRSPCE)
Proprietary sub-routine service provider reset (PSRSPRST)

Any individual or multiple service provider device (SPD), with a built-in PCRCM, is capable of communicating with any WD, with or without a built-in PCRAM, and/or any FD and/or VD through the interfaces IF_C, IF_PAN and/or IF_R respectively through a PAN and/or a WN.

Any individual or multiple wireless device (WD), with a built-in PCRAM, is capable of communicating with any service provider device (SPD), with or without a built-in PCRCM, and/or any FD and/or VD through the interfaces IF_R and/or IF_C, IF_PAN respectively through a WN and/or a PAN.

Any individual or multiple service provider device (SPD), with a built-in PCRCM, is capable of communicating with any WD and its built-in PCRAM and/or any such other WD, with or without a built-in PCRAM, and/or any FD and/or VD through the interfaces IF_C, IF_PAN and/or IF_R respectively through a PAN and/or a WN. The SPD has built-in at least one or more interfaces capable of interconnecting with the interface (IF_C) and communicating with any WD and/or FD and/or VD connected to or associated with the PAN and/or WN through the interface IF_C, IF_PAN and/or IF_R respectively.

In its most basic implementation the SPD, could be for example (but not limited to), a server or a VoIP-routing server or a desktop computer or a portable computer, with one or more interfaces IF_C. Example interfaces include (but are not limited to) one or more or a combination of a voice interface (PSTN, POTS, ISDN, E&M, . . . ) and/or data interfaces (V.5, V.11, V.35, ATM, X21, X25, DSL, XDSL, ADSL, ADSL2, ADSL2plus, SHDSL, VoIP-Gateway interface, 802.11, WiFi, WiMax, . . . ) or any such other current or future interfaces, all previous interfaces herein referred to respectively as service provider device (SPD) interfaces IF_C.

The SPD, with a built-in PCRCM, has one or more caller identification (PCRCM-CID), associated with one or more corresponding PCRCMs, that allows interconnection and/or communication with the corresponding PCRCM and one or more caller identification (SPD-CID), associated with one or more corresponding PCRCM parameters, that allows interconnection and/or communication with the SPD calls router and its parameters.

These parameters include but are not limited to:
3^{rd} party identifier (3rdPID) to connect and/or communicate and/or conference the incoming communication to the SPD-CID with, and/or enable a call back and/or call forward function, so as to allow the call forward of any incoming communication made to the SPD-CID directly towards the 3rdPID.

The PCRCM monitors each corresponding incoming communication request or incoming call from its associated PCRCM-CID input signals and automatically connects to the incoming communication, (e.g. originated by a PCRAM built-into a WD). If the incoming SIMN of the WD has permission by the parameters set within the SPD, then the SPD and/or the PCRCM will automatically connect to the corresponding detected incoming call by the PCRCM. Once the PCRCM is in communication with the corresponding incoming communication, the PCRCM will monitor and extract all the relevant data, such as but not limited to the SIMN, 3rdPID and any such other data. It will then set the parameters within the corresponding PCRCM and SPD, such as but not limited to a call divert for any future incoming calls originated from the WD, associated with the in-communication PCRAM or SIMN, made to a caller identifier associated to the SPD (SPD-CID).

In this way, after the previous process is concluded, the next time the corresponding WD (with the previously mentioned, associated SIMN) makes a call or a communication request to the SPD, by calling the corresponding or associated SPD-CID, then the SPD will automatically connect the incoming call to the 3rdPID associated with any WD, FD and/or VD and allow communication between them until either the WD or the device associated with the 3rdPID ends or terminates the call or communication.

If however the PCRCM-CID and the SPD-CID are the same identifier then the SPD and its built-in PCRCM will, in its first incoming communication, perform all the previously mentioned functions within the same communication, without the need to end or terminate the first incoming call or communication that provided the corresponding PCRCM parameters settings. It will simply proceed after the parameters settings it received (e.g. from a WD and its built-in PCRAM) to allow connection and communication between the WD, and the 3rdPID.

Any such previously mentioned first communication between the WD's PCRAM and the SPD's PCRCM, when the WD initiated a call or communication to the PCRCM-CID, can be performed in any current or future analogue and digital communications technologies, such as (but not limited to) analogue or digital data communication, PCM, ADPCM, DTMF, GPRS, WAP, VoIP. Any second communication between the WD and the SPD, when the WD initiated a call or communication to the SPD-CID, can be performed in any current and future available analogue and digital communications technologies, such as but not limited to analogue or digital voice or data, PCM, ADPCM, GPRS, WAP, VoIP.

Any individual or multiple wireless device (WD), with a built-in PCRAM, is capable of communicating with any SPD and its built-in PCRCM, and/or any other WD, with or without a PCRAM, and/or any FD and/or VD. Communication is through the interfaces IF_R and/or IF_C, IF_PAN through, respectively, a WN and/or a PAN. The WD has built-in at least one or more interfaces capable of interconnecting with the interface (IF_R) and communicating with any WD and/or FD and/or VD connected to or associated with a WN and/or a PAN through the interface IF_R and/or IF_C, IF_PAN respectively.

In its most basic implementation the WD could be (for example but not limited to), a battery powered handheld mobile phone or a handy or a wireless PC-card or a wireless module, with one or more interfaces IF_R. The interfaces could be (for example but not limited to) one or more or a combination of so called analogue interfaces (AMPS, DAMPS, . . . ) and/or so called digital interfaces (TDMA, GSM, EDGE, PCS, UMTS, . . . ) and/or one or more or a combination thereof. The interfaces can include internal interfaces and/or applications such as, but not limited to, a DTMF, Java, GPRS, WAP or any such other current or future WD analogue and/or digital-interface and/or -application. These interfaces are referred to respectively as interfaces IF_R.

The WD, with a built-in PCRAM, has a subscriber identity module number (SIMN) that allows interconnection and/or communication through the PCRAM of all its WD user set parameters. These parameters include, but are not limited to 3^{rd} party identifier (3rdPID) to connect and/or communicate and/or conference the WD with. The PCRAM monitors each outgoing communication request or outgoing call request from its associated WD. This request can include for example (but is not limited to) a phone number or internet protocol address (3rdPID) with whom the WD user wishes to communicate with and/or a phone number or internet protocol address (PCRCM-CID), associated with the corresponding PCRCM built-into a SPD, to whom the PCRAM, built-into a WD, will provide data to. The data includes, but is not limited to, the WD's SIMN, 3rdPID and any other user set parameters, such as call back and/or call forwarding and/or a phone number or internet protocol address (SPD-CID), associated with the corresponding SPD, with a corresponding built-in PCRCM, to which the PCRAM, through the WD where it is built-into, will initiate its outgoing call routing call to, in order to communicate with the 3rdCID user.

The PCRAM monitors its input signals, such that once the WD user initiates an outgoing communication request, for example (but not limited to) calling a third party phone number or a third party voice over internet protocol address, then the PCRAM through the corresponding WD and its interface IF_R automatically initiates an outgoing communication request to the user pre-defined and corresponding PCRCM-CID. Once connected and in communication with the PCRCM-CID, through the corresponding SPD and its interface IF_C, then the PCRAM will provide the corresponding PCRCM with all the relevant data, such as but not limited to the SIMN, 3rdPID and any such other data such that the parameters within the corresponding PCRCM can be set. These parameters include, but are not limited to, a call divert for any future incoming calls originated from the WD associated with the in-communication PCRAM or SIMN that will originate future communication to a caller identifier associated with the SPD (SPD-CID).

In this way, after the previous process is concluded, the next time the corresponding WD with the previous mentioned and associated SIMN or PCRAM makes a call or a communication request to the corresponding SPD, by calling the corresponding or associated SPD-CID, then the SPD will automatically connect the incoming call from, for example such previously mentioned WD to the 3rdPID. The 3rdPID could be a different WD, FD and/or VD. This process allows communication between them until either the previous mentioned call or communication originating WD or the device associated with the 3rdPID ends or terminates the call or communication.

If however the PCRM-CID and the SPD-CID are the same identifier, then the WD and its built-in PCRAM, will, whilst in communication, perform all the previous functions within the same communication, without the need to end or terminate the first outgoing call or communication that provided the PCRCM parameters settings. It will simply proceed after, providing the PCRCM the parameters, to allow connection and communication between the WD and the 3rdPID.

Any such previously mentioned first communication between the WD's PCRAM and the SPD's PCRCM, when the WD initiated a call or communication to the PCRCM-CID, can be performed in any current and future available analogue and digital communications technologies, such as but not limited to analogue or digital data communication, PCM, ADPCM, DTMF, GPRS, WAP, VoIP. Any second communication between the WD and the SPD, when the WD initiated a call or communication to the SPD-CID, can be performed in any current and future available analogue and digital communications technologies, such as but not limited to analogue or digital voice or data, PCM, ADPCM, GPRS, WAP, VoIP.

Any individual or multiple proprietary call routing control module (PCRCM), built-into or capable of interfacing and communicating with a service provider device (SPD) and/or a wireless network (WN) and/or a public access network (PAN), and any individual or multiple proprietary call routing application module (PCRAM), built-into or capable of interfacing and communicating with a wireless device (WD), may be located in the same geographical area (country 1) or in a different geographical area (country 2 to country n).

Any individual or multiple service provider device (SPD), with a built-in PCRCM, and any individual or multiple wireless device (WD), with a built-in PCRAM, is capable of communicating with each other.

Any individual or multiple proprietary call routing control module (PCRCM), is either built-into or is capable of interfacing and/or interconnecting and communicating with a SPD and/or a PAN and/or a WN, and any individual or multiple proprietary call routing application module PCRAM built-into a wireless device (WD), is capable of communicating with each other.

Any individual or multiple service provider device (SPD), with a built-in PCRCM, and any individual or multiple wireless device (WD), with a built-in PCRAM, is capable of communicating with each other.

Any individual or multiple service provider device (SPD), with a built-in PCRCM, and any individual or multiple wireless device (WD), where the WD is capable of downloading and installing a PCRAM, are capable of communicating with each other once the PCRAM has been downloaded and installed.

Similarly, any individual or multiple wireless device (WD), with a built-in PCRAM, and any individual or multiple service provider device (SPD), where the SPD is capable of downloading and installing a PCRCM are capable of communicating with each other once the SPD installs the PCRCM.

Any individual or multiple wireless device (WD), with a built-in PCRAM, and any individual or multiple service provider device (SPD), with a built-in PCRCM, are capable of communicating with each other.

Any individual or multiple proprietary call routing control module (PCRCM), may be built-into or capable of interfacing and communicating with a service provider device (SPD) and/or a wireless network (WN) and/or a public access network (PAN), and any individual or multiple proprietary call routing application module (PCRAM), may be built-into or capable of interfacing and communicating with a wireless device (WD) and/or fixed device (FD) and/or a voice over internet protocol device (VD), capable of communicating with each other, through one or more public access networks (PAN) and/or one or more wireless networks (WN). All of the previous may be located in the same geographical area (country 1) or in a different geographical area (country 2 to country n).

The system works even with only the PCRCM and without the PCRAM, in which case the user will have to manually input the functions the PCRAM would perform on any device connecting through the internet to the PCRCM.

Many modifications and variations of this present invention are possible in view of the above disclosures, drawings and explanations. Thus, it is to be understood that, within the scope of the appended claims, the invention can be practiced other than as specifically described herein above. The invention which is intended to be protected herein should not, however, be construed as limited to the particular forms disclosed, or implementation examples outlined, as these are to be regarded as illustrative rather than restrictive. Variations in changes could be made by those skilled in the art without deviating from the spirit of the invention. Accordingly, the foregoing detailed descriptions and drawings should be considered exemplary in nature and not limited to the scope and spirit of the invention as set forth in the claims herein.

1. A method of enabling call routing from a wireless device, comprising the steps of:
(a) the wireless device using a software application that enables the device to communicate with a remote service provider device over a wireless link;
(b) the user initiating a call to a third party by dialing the telephone number of the third party the user wishes to communicate with;
in which the method comprises the further steps of:
(c) the software application then automatically initiating a data communication to the remote service provider and automatically providing to the remote service provider device all the required information needed by the service provider device to correctly route the communication.

2. The method of claim 1 in which the required information automatically provided by the software application over the data communication to the remote service provider device includes the telephone number of the third party.

3. The method of claim 1 in which the required information automatically provided by the software application over the data communication to the remote service provider device includes a device identifier.

4. The method of claim 1 in which the required information automatically provided by the software application over the data communication to the remote service provider device includes a SIM number for the device.

5. The method of claim 1 in which the required information automatically provided by the software application over the data communication to the remote service provider device includes a user account login and user account password.

6. The method of claim 1 in which the remote service provider device verifies permission to use the remote service provider device.

7. The method of claim 1 in which the remote service provider device automatically arranges for voice communication between the user and the third party.

8. The method of claim 7 in which the remote service provider device terminates the data communication.

9. The method of claim 7 in which the new voice communication is a call to the user and another call to the third party, which is then conferenced or joined together.

10. The method of claim 7 in which the wireless device automatically makes a voice call to the remote service provider device and that voice call is automatically forwarded or diverted to the third party.

11. The method of claim 7 in which the new voice communication is an automatic voice call back to the user and another call to the third party, which are then conferenced or joined together.

12. The method of claim 1 in which the data communication is over GPRS.

13. The method of claim 1 in which the data communication is set up by the device dialing an IP address.

14. The method of claim 1 in which the software application is downloadable by the user to the wireless device.

15. The method of claim 14 in which the download is by SMS or WAP.

16. The method of claim 1 in which the remote service provider device can also be accessed using a computer over the internet.

17. The method of claim 1 in which the remote service provider device decides on the appropriate routing for a given call request from the wireless device.

18. The method of claim 17 in which the remote service provider device automatically determines the lowest cost route from a number of routes provided by different operators.

19. The method of claim 18 in which the remote service provider device can route over IP, or wired or wireless, or a combination of any of these.

20. A wireless device when running a software application that enables call routing, in which:
(a) the wireless device uses a software application that enables the device to communicate with a remote service provider device over a wireless link, the user initiating a call to a third party by dialing the telephone number of the third party the user wishes to communicate with;
(b) the software application then automatically initiates a data communication to the remote service provider and automatically provides to the remote service provider device all the required information needed by the service provider device to correctly route the communication.

21. (canceled)
